(19) United States
(12) Patent Application Publication
(10) Pub. No.: US 2025/0026218 A1
(43) Pub. Date: Jan. 23, 2025

(54) OVERHEAD POWER DISTRIBUTION SYSTEMS AND METHODS FOR MODULAR EXPANDABLE OUTDOOR BUSWAY

(71) Applicants: Siemens Industry, Inc., Alpharetta, GA (US); Nexii Building Solutions Inc., Vancouver (CA)

(72) Inventors: James Washburn, Buford, GA (US); Anders Thulin, Minneapolis, MN (US); Brian J. Rusch, Suwanee, GA (US); Allanah Brown, Vancouver (CA); Louis Dombowsky, Vancouver (CA); Ben Dombowsky, Squamish (CA); Michael Dombowsky, Squamish (CA); John Riley, Aspen, CO (US)

(73) Assignees: Siemens Industry, Inc., Alpharetta, GA (US); Nexii Building Solutions Inc., Vancouver, BC (CA)

(21) Appl. No.: 18/707,087

(22) PCT Filed: Sep. 1, 2022
(86) PCT No.: PCT/US2022/042344

§ 371 Date: May 2, 2024

Related U.S. Application Data
(60) Provisional application No. 63/263,492, filed on Nov. 3, 2021.
(60) Provisional application No. 63/293,461, filed on Dec. 23, 2021.

(51) Int. Cl. B60L 53/31; H02G 3/04

(52) U.S. Cl. CPC B60L 53/31; H02G 3/0493

(57) ABSTRACT

A modular system for distributing electric power is provided for busway applications. The system includes a plurality of columns. Each of the plurality of columns are spaced apart from one another. The system further includes an electric power distribution system configured to supply electric power. The electric power distribution system is elevated by the plurality of columns and coupled to an electric power source. The system further includes a canopy at least partially enclosing the electric power distribution system. The canopy is structurally supported by the plurality of columns and spanning between adjacent ones of the plurality of columns. The system further includes a plurality of electric vehicle chargers coupled to the plurality of columns. Each of the plurality of electric vehicle chargers are electrically coupled to the electric power distribution system.

### CROSS REFERENCE TO RELATED APPLICATIONS

This application claims the benefit of U.S. Provisional Application Ser. No. 63/263,492 entitled “MODULAR EXPANDABLE OUTDOOR BUSWAY SYSTEM,” filed on Nov. 3, 2021, the contents of which are hereby incorporated by reference herein in their entirety. This application also claims the benefit of U.S. Provisional Application Ser. No. 63/293,461 entitled “OVERHEAD POWER DISTRIBUTION SYSTEMS AND METHODS,” filed on Dec. 23, 2021, the contents of which are hereby incorporated by reference herein in their entirety.

### BACKGROUND

### 1. Field

Aspects of the present invention generally relate to overhead power distribution systems and methods for modular expandable outdoor busway applications. Example embodiments provide modular systems and methods for distributing electrical power to electric vehicle chargers.

### 2. Description of the Related Art

Being able to efficiently run a fleet of electric vehicles requires electric charging capabilities which permit simultaneous charging of many vehicles in the fleet. In order to charge many vehicles at a time, a large number of electric vehicle chargers must be provided.

Additionally, distributing large amounts of electrical power typically requires large scale infrastructure which is difficult to install in many settings. For example, large towers (e.g., about 100 feet (about 30.5 meters) high and about 60 feet (about 18.3 meters) wide) may be required to support high voltage electrical power lines. Contact with such power lines may cause serious injuries, death, serious damage to property, etc. There remains a need for practical and cost effective ways to install large numbers of electric vehicle chargers, for example in outdoor parking lots.

Modular freestanding enclosure systems for busway systems are needed. Until now however, freestanding electrical systems required the use of traditional cable-based power transmission. Busway has not been able to be used in this application in the past. Cable based systems are typically buried underground or have cable and conduit surface mounted to an existing structure (e.g., building, parking structure, etc.).

Therefore, there is a need for a better overhead power distribution system for modular expandable outdoor busway applications.

### SUMMARY

Briefly described, aspects of the present invention relate to an overhead power distribution system for modular expandable outdoor busway applications. This invention has a number of aspects. These include, without limitation:
systems and methods for delivering electrical power to a plurality of electric vehicle chargers;
systems and methods for installing a plurality of electric vehicle chargers at a site;
systems and methods for delivering electrical power;
systems for elevating an electric power distribution system;
systems for enclosing an electric power distribution system.

In accordance with one illustrative embodiment of the present invention, a modular system for distributing electric power is provided for busway applications. The system includes a plurality of columns. Each of the plurality of columns are spaced apart from one another. The system further includes an electric power distribution system configured to supply electric power. The electric power distribution system is elevated by the plurality of columns and coupled to an electric power source. The system further includes a canopy at least partially enclosing the electric power distribution system. The canopy is structurally supported by the plurality of columns and spans between adjacent ones of the plurality of columns. The system further includes a plurality of electric vehicle chargers coupled to the plurality of columns. Each of the plurality of electric vehicle chargers are electrically coupled to the electric power distribution system.

In accordance with one illustrative embodiment of the present invention, a method of installing and using an electric power distribution system at an installation site is described. The method comprises installing a plurality of columns at the installation site in spaced apart relation. The method further comprises connecting upper portions of the columns together with a canopy. The canopy is configured to support the electric power distribution system. The method further comprises electrically coupling the electric power distribution system to one or more electrical devices mounted on the columns.

In accordance with one illustrative embodiment of the present invention, a modular system for delivering electrical power is provided. The system comprises a plurality of columns. Each of the plurality of columns are spaced apart from one another. The system further includes an electric power distribution system configured to transmit electric power. The electric power distribution system is elevated by the plurality of columns and coupled to an electric power source. The system further includes a canopy at least partially enclosing the electric power distribution system. The canopy is structurally supported by the plurality of columns and spans between upper portions of adjacent ones of the plurality of columns.

In accordance with one illustrative embodiment of the present invention, a modular system for delivering electrical power is provided. The system comprises an electric power distribution system configured to transmit electric power. The electric power distribution system is elevated relative to a ground surface and coupled to an electric power source. The system further comprises a canopy at least partially enclosing the electric power distribution system.

In accordance with one illustrative embodiment of the present invention, a method for delivering electrical power is described. The method comprises coupling an electric power distribution system to an electric power source. The method further comprises at least partially enclosing the electric power distribution system with a canopy. The method further comprises elevating the electric power distribution system and canopy relative to a ground surface.

In accordance with one illustrative embodiment of the present invention, a freestanding outdoor modular enclosure system is provided for busway applications. The system comprises a busway system configured to deliver electricity to installed loads and/or receive power from utility or non-utility power sources. The system further comprises one or more load bearing vertical pillars configured to be anchored into the ground. The system further comprises a horizontal beam system which is topped on the one or more load bearing vertical pillars. The horizontal beam system supports a weight load of the busway system. The system further comprises an enclosure to house the busway system to limit exposure to weather elements. The freestanding outdoor modular enclosure system is modular and expandable and can be extended in modules to accommodate specific installation requirements.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is a perspective view of an electric power distribution system in accordance with an exemplary embodiment of the present invention.

FIG. 2 is a partially exploded perspective view of an example canopy in accordance with an exemplary embodiment of the present invention.

FIGS. 3 and 4 are perspective views of example canopy elements in accordance with an exemplary embodiment of the present invention.

FIG. 5 is a perspective view of example sheathing coupled to a canopy in accordance with an exemplary embodiment of the present invention.

FIGS. 6 and 7 are cross-sectional views of example canopies in accordance with an exemplary embodiment of the present invention.

FIG. 8 is a schematic illustration of an example electric power distribution system as described herein installed at a site (e.g. a parking lot) in accordance with an exemplary embodiment of the present invention.

FIG. 9 is a schematic illustration of an electric vehicle using an example electric power distribution system described herein to re-charge its battery in accordance with an exemplary embodiment of the present invention.

FIGS. 10 and 11 are schematic illustrations of example electric power distribution systems as described herein installed at sites (e.g. parking lots) in accordance with an exemplary embodiment of the present invention.

FIG. 12 is a schematic illustration of an example electric power distribution system in accordance with an exemplary embodiment of the present invention.

FIG. 13 is a schematic illustration of an example electric power distribution system in accordance with an exemplary embodiment of the present invention.

FIG. 14 is a perspective view of a completed assembly including vertical sections including a crush zone, screw pile anchors with a leveling plate, and horizontal cross beams, a busway system with busplugs mounted on a mounting cross bar, and a top cover in accordance with an exemplary embodiment of the present invention.

FIGS. 15-16 show side and front views of the completed assembly including vertical sections, the screw pile anchors with the leveling plate and the horizontal cross beams, the busway system with busplugs, and the top cover in accordance with an exemplary embodiment of the present invention.

FIGS. 17-21 show details of vertical components of a vertical structure in accordance with an exemplary embodiment of the present invention.

FIGS. 22-26 detail steel vertical components which are encased in a vertical panel such that the steel vertical structures are anchored to the top of the leveling plate in accordance with an exemplary embodiment of the present invention.

FIGS. 27-29 detail a bottom portion of the vertical structure that is designed as a replaceable crush zone in accordance with an exemplary embodiment of the present invention.

FIGS. 30-33 detail a screw pile anchoring system and the leveling plate that ensures that the vertical components are installed correctly in accordance with an exemplary embodiment of the present invention.

FIGS. 34-38 show horizontal components of horizontal assemblies wherein the horizontal components are comprised of steel cross beam, the busway system including mounting cross bars, busduct, busplugs and tap boxes in accordance with an exemplary embodiment of the present invention.

FIG. 39 illustrates a freestanding outdoor modular enclosure system for busway applications in accordance with an exemplary embodiment of the present invention.

FIG. 40 illustrates a schematic view of a flow chart of a method of installing and using the electric power distribution system at an installation site in accordance with an exemplary embodiment of the present invention.

FIG. 41 illustrates a schematic view of a flow chart of a method of delivering electrical power in accordance with an exemplary embodiment of the present invention.

### DETAILED DESCRIPTION

Various technologies that pertain to systems and methods that facilitate an overhead power distribution system for a modular expandable outdoor busway will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

To facilitate an understanding of embodiments, principles, and features of the present invention, they are explained hereinafter with reference to implementation in illustrative embodiments. In particular, they are described in the context of an overhead power distribution system for a modular expandable outdoor busway. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

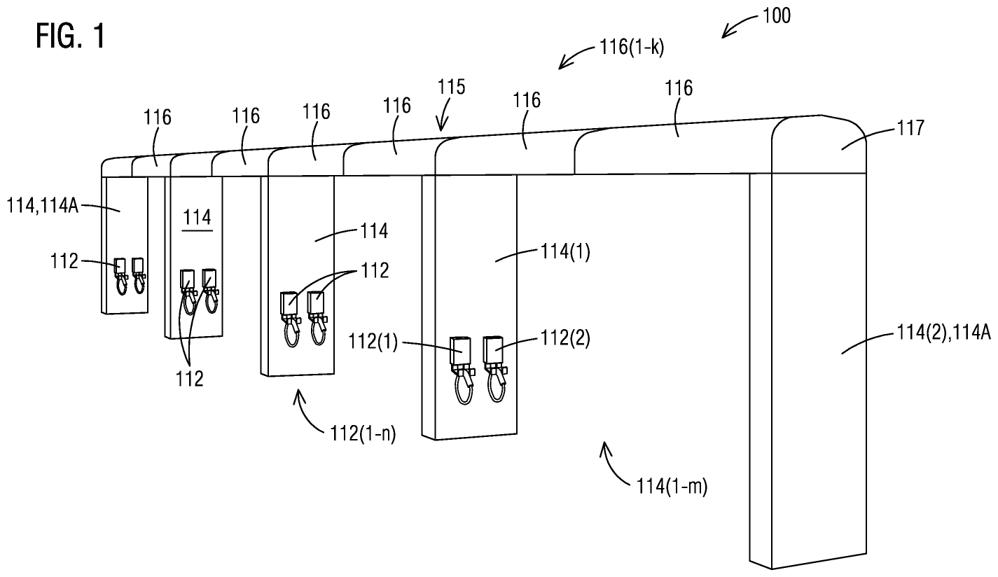

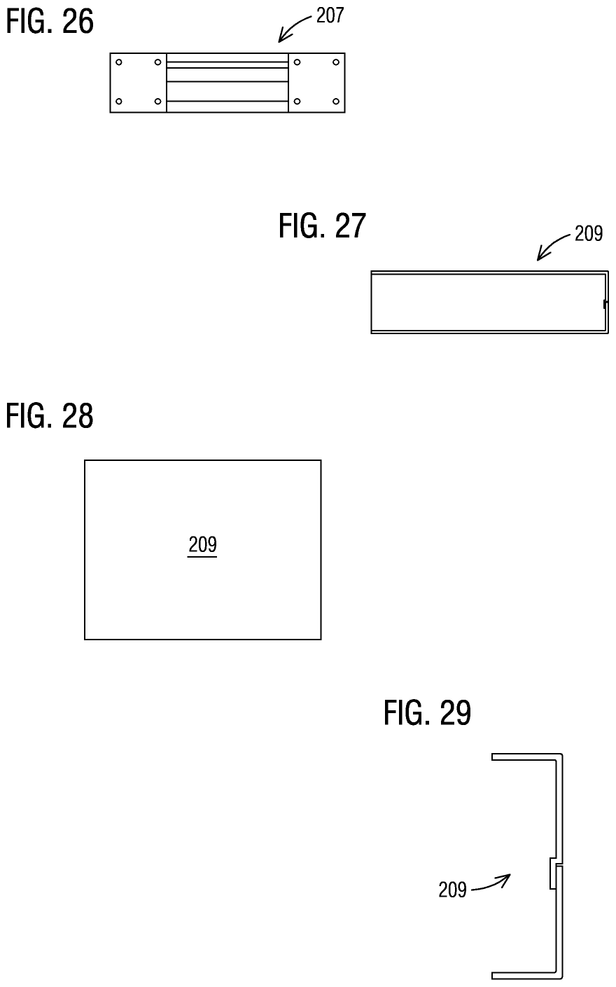

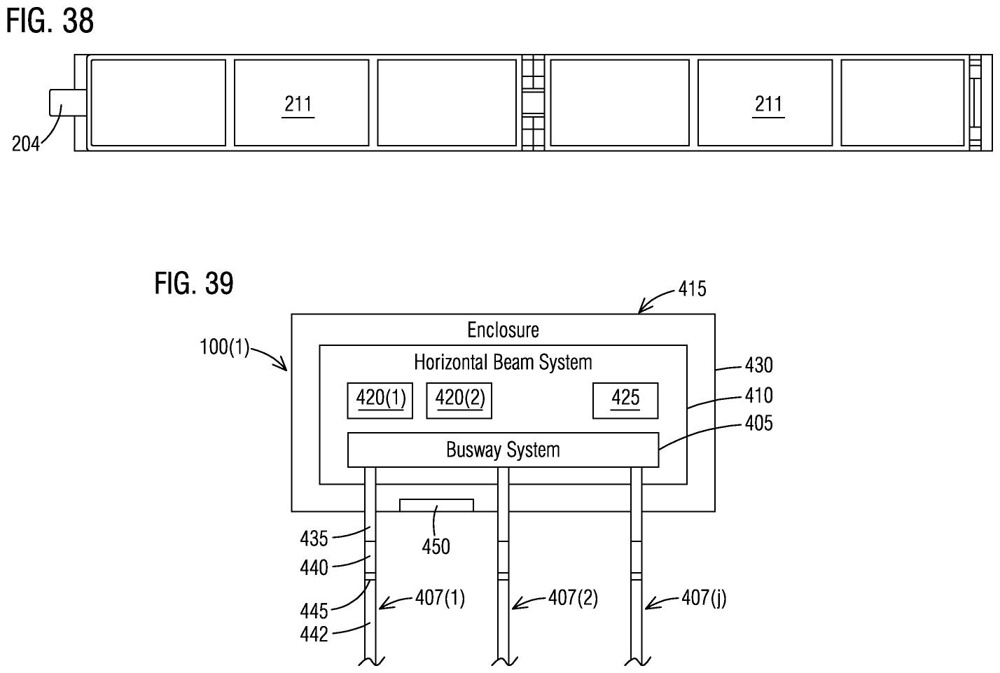

These and other embodiments of the overhead power distribution system and methods according to the present disclosure are described below with reference to FIGS. 1-41 herein. Like reference numerals used in the drawings identify similar or identical elements throughout the several views. The drawings are not necessarily drawn to scale.

One aspect of the technology described herein provides a modular system for distributing electrical power to a plurality of electric vehicle chargers. In some embodiments the system provides electrical power to several hundreds or thousands of electric vehicle chargers. Components of the system may be pre-fabricated and shipped to a site for installation. The system may be rapidly installed at the site once the pre-fabricated components arrive. The modularity of the system may permit a size or capacity of the system to be varied as performance or scale requirements change.

Consistent with one embodiment of the present invention, FIG. 1 represents a perspective view of an example overhead power distribution system 100 in accordance with an exemplary embodiment of the present invention. The overhead power distribution system 100 may distribute electrical power to a plurality of electric vehicle chargers 112(1-n). In some embodiments the overhead power distribution system 100 distributes electrical power to a large number (e.g., several hundreds or thousands) of the electric vehicle chargers 112(1-n). The system 100 may be particularly advantageous for electrically charging fleets of electric vehicles at a site such as a parking lot.

The overhead power distribution system 100 comprises a plurality of spaced apart columns 114(1-m). The columns 114(1-m) may be installed generally vertical. The columns 114(1-m) may be prefabricated. In some embodiments, the columns 114(1-m) comprise prefabricated panels. In some embodiments, the columns 114(1-m) may be designed to withstand one or more vehicular impacts. Designing the columns 114(1-m) to withstand one or more vehicular impacts may advantageously reduce or eliminate the need to install protective barriers around the columns 114(1-m) (e.g. such as protective bollards) thereby simplifying construction of the system 100 (e.g. reducing how much time is needed to construct the system 100, reducing expenses, etc.).

The columns 114(1-m) may, for example, have a height from about 6 feet (about 1.82 meters) to about 20 feet (about 6.1 meters).

One or more electric vehicle chargers 112(1-n) may be coupled to a column 114. In some embodiments two electric vehicle chargers 112 are mounted on first and second opposing faces of one or more columns 114 (e.g. 4 electric vehicle chargers 112 per column 114). In some embodiments different columns 114(1-m) have different numbers of electric vehicle chargers 112(1-n). For example, end columns 114A may each only have one face with electric vehicle chargers 112(1-n) whereas other columns 114 have two faces with electric vehicle chargers 112. Different faces of a column 114 may have different numbers of electric vehicle chargers 112.

The columns 114(1-m) elevate and structurally support an electric power distribution system 113 (see e.g., FIG. 7) which supplies electrical power to electric vehicle chargers 112. In some embodiments, the electric power distribution system 113 may distribute high current (e.g., at least several hundreds of Amperes) and/or high voltage (e.g., at least several hundreds or thousands of Volts) electrical power. In some embodiments, the electric power distribution system 113 comprises one or more electric busways.

The electric power distribution system 113 may receive electrical power in any manner. In some embodiments, the electric power distribution system 113 receives electrical power from a below-ground source (e.g., buried power lines, a below ground generator, etc.). For example, the electric power distribution system 113 may be coupled to the below-ground power source by an electrical connection running through a column 114. In some embodiments, the electric power distribution system 113 receives electrical power from an above-ground source such as a power line, generator, a nearby building and/or the like. In some embodiments, the system 100 may generate its own electrical power to power the electric power distribution system 113 (e.g., solar panels or solar cells 120 (see e.g., FIG. 12) coupled to a canopy 115 may provide electrical power as described elsewhere herein).

In some embodiments, the columns 114 (or portions of columns 114) are electrically coupled to physical ground surfaces of a site and therefore may electrically ground the electric power distribution system 113 and/or the system 100 (e.g., canopy 115, columns 114, electric vehicle chargers 112, etc.). In some embodiments, the columns 114 are easily anchored in the ground at an installation site. In some embodiments, the columns 114 are free-standing.

The canopy 115 may enclose the electric power distribution system 113 to protect the electric power distribution system 113 from environmental elements (e.g., rain, snow, hail, wind, etc.). Additionally, or alternatively, enclosing the electric power distribution system 113 may prevent or reduce the likelihood of inadvertent electric shocks being delivered to humans, animals, property, etc. The columns 114(1-m) may structurally support the canopy 115 (and any loads exerted on the canopy 115 such as snow loads, additional devices or elements that are coupled to the canopy 115, etc.). Additionally, or alternatively, the canopy 115 may structurally couple the columns 114 together. For example, the canopy 115 may increase an overall shear strength of individual columns 114.

Although the canopy 115 has been shown as being coupled to tops of the columns 114(1-m), in some embodiments the canopy 115 may be coupled to one or more side surfaces of the columns 114.

It may, for example, be desirable to maintain the electric power distribution system 113 and/or the canopy 115 level. In some such cases different columns 114 may have different heights in order to account for different ground elevations and maintain the electric power distribution system 113 and/or the canopy 115 level.

In some embodiments, the canopy 115 may be coupled to the columns 114(1-m) to slope downwards relative to the ground surface (e.g., slopes downwards from one column 114 at one end to another column 114 at another end of the system 100). Coupling the canopy 115 such that it slopes downwards may, for example, assist with directing water away from the system 100 during a rainstorm and/or the like. In some embodiments, water collecting features such as gutters or the like may be coupled to the canopy 115 (e.g., to sides of the canopy 115).

In some embodiments, elements of the system 100 (e.g., columns 114, canopy 115, the electric power distribution system 113, etc.) are manufactured off site and may be rapidly installed at the site once delivered.

As shown in FIG. 2, the canopy 115 may comprise a plurality of individual canopy elements 116(1-k) (as shown in e.g., FIGS. 1, 2) which are coupled together. Outer surfaces of individual canopy elements 116 (and therefore an outer surface of the canopy 115) may be shaped to direct moisture, snow, debris, etc. down the side edges of the canopy elements 116 (and the canopy 115). The canopy element 116 may, for example, be made of a metal (e.g. steel, aluminum, etc.), fiberglass, plastic and/or the like. In some embodiments, the canopy element 116 is electrically insulative (i.e. not electrically conductive). The canopy 115 may be configured in some embodiments to enclose and protect the electric power distribution system 113 in outdoor environments (e.g. uncovered outdoor parking lots) although the components of the system 100 could also be installed indoors or in partially covered or protected environments.

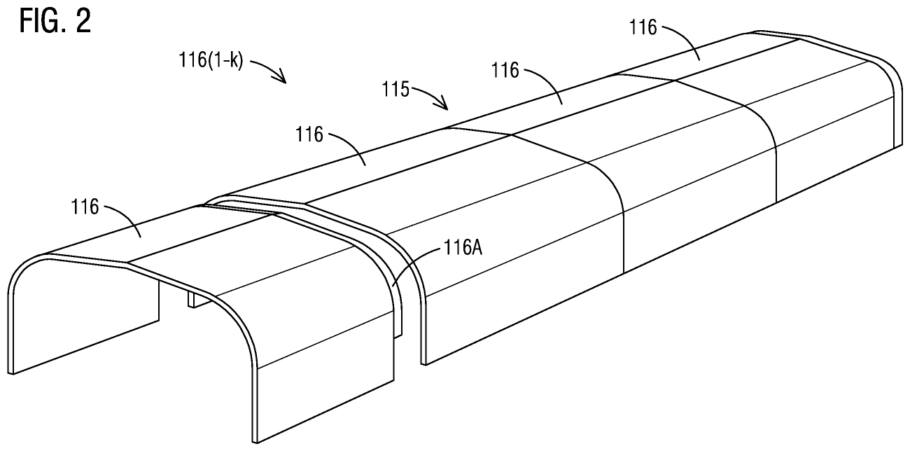

FIGS. 3 and 4 illustrate example embodiments of a canopy element 116. An end of the canopy element 116 may comprise a lip 116A or other member that engages an opposing end of an adjacent canopy element 116 to provide a tight fit between adjacent canopy elements 116. In some embodiments, the lip 116A frictionally engages the opposing end of the adjacent canopy element 116. In some embodiments, the interface between adjacent canopy elements 116(1-k) comprises a male female mating connection. In some embodiments, the interface between adjacent canopy elements 116 comprises locking tabs or the like which can easily be coupled together or uncoupled from one another. In some embodiments, the interface between adjacent canopy elements 116 is sealed to prevent ingress of moisture, pests, etc. In some embodiments, the seal comprises a compressible seal such as a foam gasket, rubber gasket, etc. In some embodiments, the compressible seal is coupled to the lip 116A. In some embodiments the seal comprises a commercially available sealant.

In some embodiments, interfaces between adjacent canopy elements 116 may permit movement of one canopy element relative to the adjacent canopy element to account for vibrations, movement and/or the like of the canopy 115 without the adjacent canopy elements uncoupling from one another. Additionally, or alternatively, the columns 114(1-m) may reduce or dampen vibrations, movement and/or the like of the canopy 115 (or canopy elements 116).

An open end of a canopy element 116 (e.g. at an end of the canopy 115) may be closed-off with a cap 117 as shown in e.g., FIGS. 1, 4. The cap 117 may close-off the open end of the canopy 115 to protect the electric power distribution system 113, prevent ingress of moisture and/or pests, etc. In some embodiments, one or more interfaces between the cap 117 and the canopy element 116 may be sealed. The seal may comprise a foam gasket, rubber gasket, liquid applied sealant, caulking and/or the like. In some embodiments, the cap 117 is removably coupled to the canopy element 116.

Preferably, the canopy elements 116 may easily be coupled together and/or uncoupled from one another. Additionally, or alternatively, the cap 117 preferably may easily be coupled to and/or uncoupled from the canopy element 116.

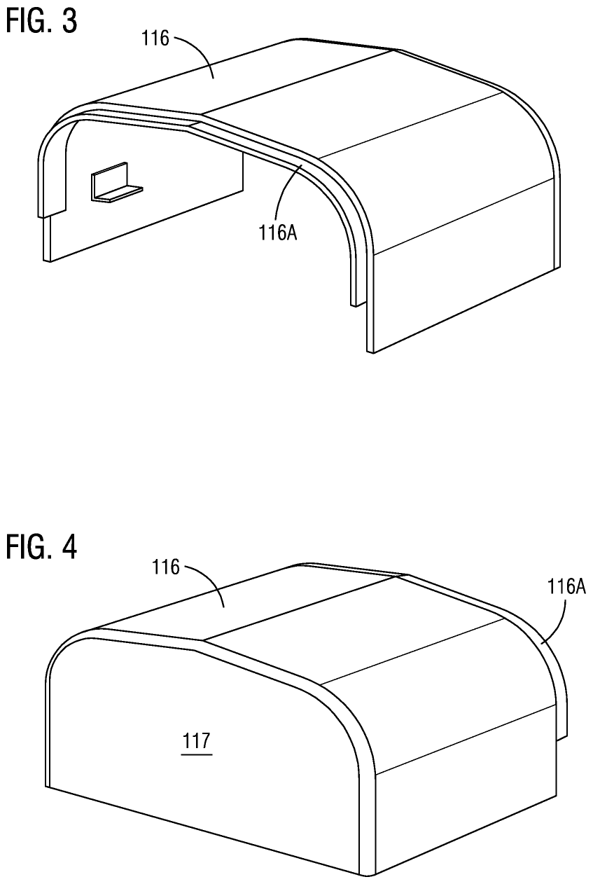

FIG. 5 is a perspective view of example sheathing 118 coupled to the canopy 115 in accordance with an exemplary embodiment of the present invention. The sheathing 118 may cover a bottom portion of the canopy 115 (see e.g., FIG. 5). The sheathing 118 may, for example, comprise soffit sheets or soffit-like sheets. The sheathing 118 may be made of metal (e.g. steel, aluminum, etc.), fiberglass, plastic and/or the like. The sheathing 118 may be made of the same or a different material than the canopy elements 116. In some embodiments, the sheathing 118 is electrically insulative. The sheathing 118 and/or the canopy elements 116 may comprise one or more apertures or the like to vent the canopy 115. Venting the canopy 115 may, for example, dissipate heat from inside the canopy 115 (e.g., to keep the electric power distribution system 113 within a safe operating temperature).

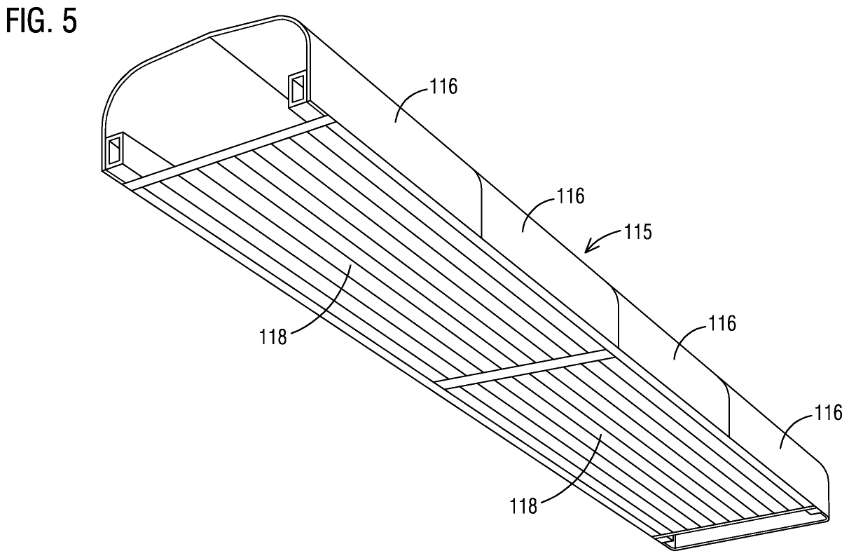

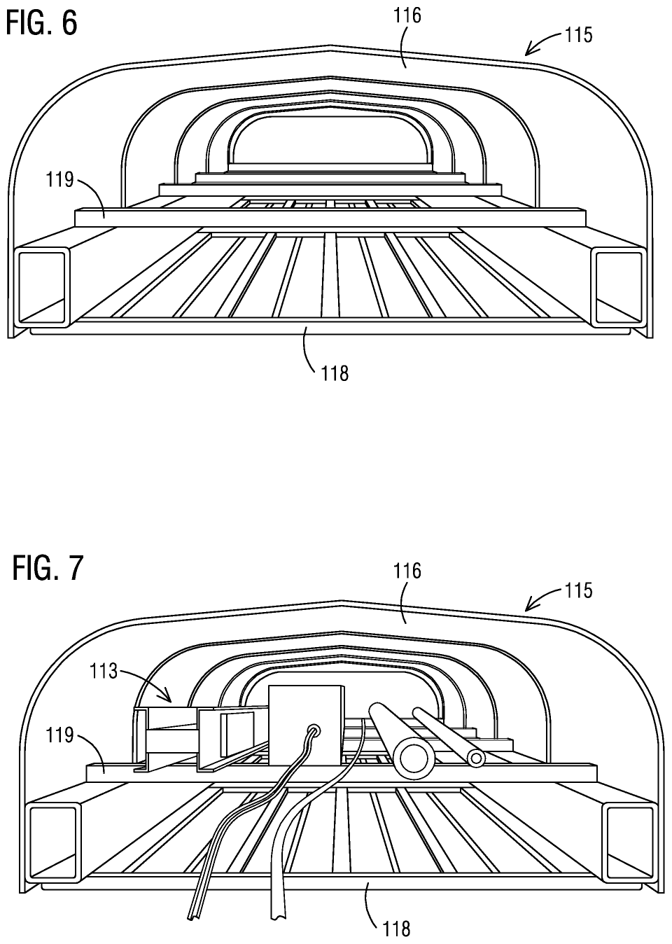

FIG. 6 is a cross-sectional view of an example canopy 115. As shown in FIG. 6, the canopy 115 may comprise a plurality of cross-bars 119. The cross-bars 119 may, for example, support and/or stabilize the electric power distribution system 113. In some embodiments, the cross-bars 119 at least partially level the electric power distribution system 113 within the canopy 115. In some embodiments, the cross-bars 119 at least partially isolate the electric power distribution system 113 from vibrations, movements and/or the like of the canopy 115 (or the system 100). Additionally, or alternatively the cross-bars 119 may at least partially dampen vibrations, movements and/or the like of the canopy 115 (or the system 100) which may be exerted on the electric power distribution system 113. In some embodiments, the cross-bars 119 are electrically isolated from the electric power distribution system 113. FIG. 7 is a cross-sectional view of an example canopy 115 with an example electric power distribution system 113 supported by cross-bars 119.

As described herein the electric vehicle chargers 112 are electrically coupled to the electric power distribution system 113. In some embodiments, a plurality of junction boxes are installed within a canopy 115. The electric vehicle chargers 112 may be coupled to the electric power distribution system 113 within the junction boxes. In some embodiments, a junction box is installed for each electric vehicle charger 112. In some embodiments, a junction box is installed for each group of electric vehicle chargers 112 (e.g., electric vehicle chargers 112 of a column 114, electric vehicle chargers 112 coupled to the same side of the column 114, etc.).

In some embodiments, one or more additional elements or devices are required to couple the electric vehicle chargers 112 to the electric power distribution system 113. For example, a voltage may need to be stepped-down (i.e. lowered) before it can be supplied to an electric vehicle charger 112. In some such cases one or more step-down transformers or the like may be installed within the canopy 115 to lower a voltage of electrical power from the electric power distribution system 113 prior to the electrical power being supplied to an electric vehicle charger 112.

In some embodiments, one or more cooling elements (e.g., air circulation fans, liquid cooling elements, etc.) are installed within the canopy 115. The cooling element(s) may, for example, maintain a temperature inside the canopy 115 to be within a safe operating range of the electric power distribution system 113.

The canopy 115 (or canopy elements 116 and/or sheathing 118) may comprise one or more access points. Such access points may, for example, permit access to the electric power distribution system 113, devices or components installed within the canopy 115 and/or the like. In some embodiments, one or more of the access points are covered with a removable cover.

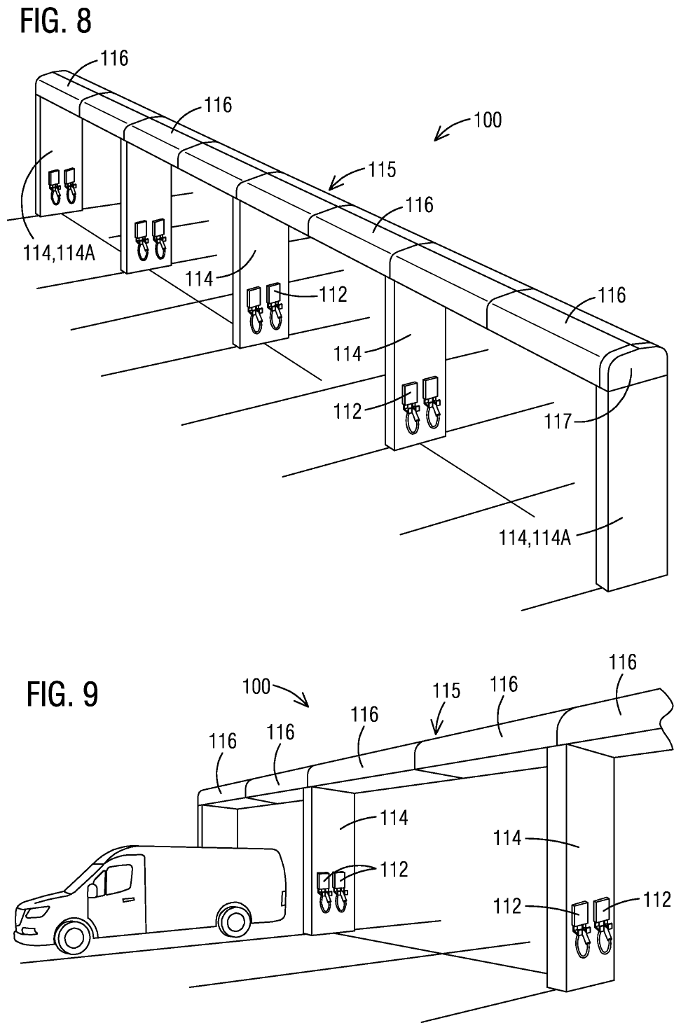

FIG. 8 illustrates an example installation of the system 100 in a parking lot. In the illustrated example case of FIG. 8 the electric power distribution system 113 of the system 100 may be connected to a below-ground power source through an electrical connection running through a column 114 as described elsewhere herein.

The system 100 is preferably modular and therefore a size and capacity of the system 100 may be varied by adding or removing columns 114, canopy elements 116 and/or electric vehicle chargers 112. In some embodiments, the electric power distribution system 113 advantageously need not be re-balanced upon varying the system 100 to add or remove columns 114, canopy elements 116 and/or electric vehicle chargers 112.

For example, to increase capacity of the system 100 shown in FIG. 8 one or more additional columns 114 may be installed and one or more canopy elements 116 may extend the canopy 115. The canopy 115 may, for example, be expanded by removing the cap 117 from an end of the canopy 115, coupling one or more new canopy elements 116 to the canopy 115 and coupling the cap 117 to the new end of canopy 115. The extended canopy 115 may also be coupled to any new columns 114.

As another example, to reduce capacity of the system 100 the cap 117 may be removed from an end of the canopy 115, one or more canopy elements 116 may be uncoupled from the canopy 115 (and/or one or more columns 114) and the cap 117 may be coupled to the new end of the canopy 115. Any columns 114 not supporting the canopy 115 may be removed.

In some embodiments, the electric power distribution system 113 is modular. For example, individual components of the electric power distribution system 113 may be pre-installed within a canopy element 116. Coupling two adjacent canopy elements 116 may automatically couple the corresponding two components of the electric power distribution system 113 together. Making the electric power distribution system 113 modular may advantageously increase an installation speed of the system 100, make the system 100 easier to install and/or the like. In some embodiments, the modular components of the electric power distribution system 113 may quickly and easily be installed at an installation site, such as a pre-existing parking lot. Thus, a parking lot can be easily retrofitted to enable large-scale electric vehicle charging without significant trenching and resurfacing of the parking lot surface.

FIG. 9 illustrates an electric vehicle using the system 100 to charge its battery(ies).

The system 100 may be installed in any configuration. For example, the system 100 may be installed:
as a plurality of linear rows;
as a continuous unitary system;
in a circular arrangement;
in a polygonal arrangement;
in an arrangement that has a main section and subsections which branch off of the main section (e.g. a “tree” like arrangement);
in an arrangement that has a plurality of interconnected nodes network where one or more branches branch off of each of the nodes (e.g. a circular network of nodes, a star network of nodes, etc.);
any combination of the above; etc.

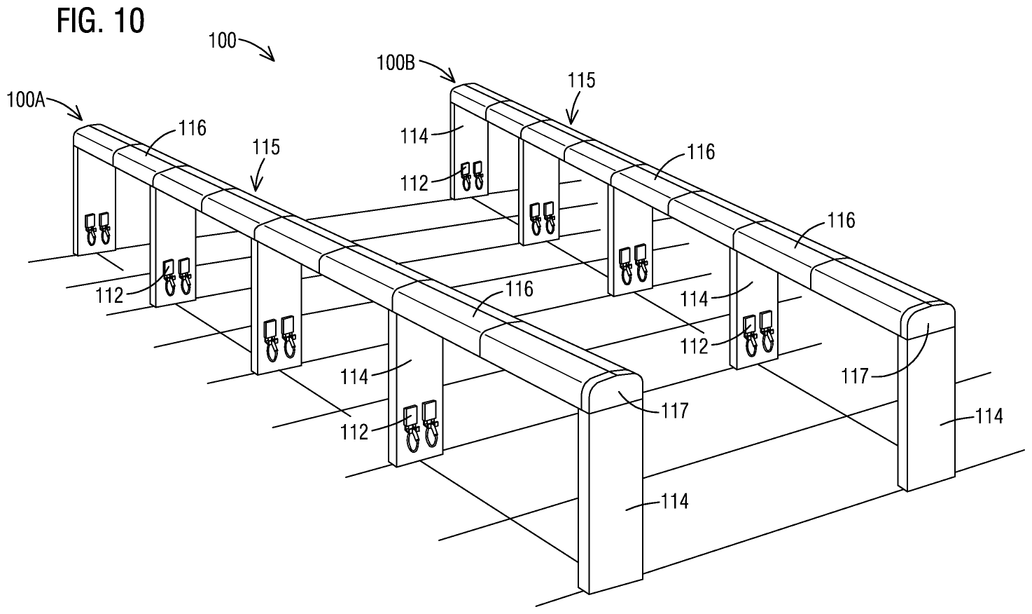

FIG. 10 illustrates an example system 100 installed in a plurality of rows (e.g. rows 100A and 100B). The individual rows of such system 100 may be connected to a power source in series (e.g., the row 100A is connected to the power source and the row 100B is connected to row 100A), in parallel (e.g., rows 100A and 100B are both individually connected to the power source) or partially in series and partially in parallel (for embodiments having more than two rows).

In some embodiments, the canopy 115 and/or the electric power distribution system 113 continuously span an entire system 100. For example, FIG. 11 illustrates an example system 100 installed in a “U” shaped configuration. In such example case, the canopy 115 extends continuously across the entirety of the system 100. The electric power distribution system 113 within the canopy 115 may extend continuously within the entirety of the canopy 115; however, it is not mandatory.

In some embodiments, the system 100 may at least partially self-generate its electric power. For example, the canopy 115 may support one or more commercially available solar panels or solar cells 120 (see e.g., FIG. 12). Electrical power generated by solar panels or solar cells 120 may be supplied to the electric power distribution system 113 to be distributed to the electric vehicle chargers 112, stored (e.g., in batteries) for later distribution to the electric vehicle chargers 112 and/or the like.

Typically, installing the system 100 at a site comprises:
installing the columns 114;
installing the canopy 115; and
installing the electric power distribution system 113.

In some cases, two or more of the above steps are performed concurrently (e.g., the canopy 115 may be installed and coupled to already installed columns 114 while additional columns 114 are being installed).

In some embodiments, technicians install the electric vehicle chargers 112 to the columns 114 once the columns 114, the canopy 115 and the electric power distribution system 113 are installed (not necessary in all cases). In some embodiments, the electric vehicle chargers 112 are pre-coupled to the columns 114. In some embodiments, the electric vehicle chargers 112 are installed concurrently with one or more of columns 114, the canopy 115 and the electric power distribution system 113.

One or more components of the electric power distribution system 113 may be electrically isolated from one another to prevent short-circuiting of the components of the electric power distribution system 113, inadvertent connections (e.g., inadvertent electrical connections with unintended components of the system 100) and/or the like.

Although the system 100 has been described in association with distributing electrical power to the electric vehicle chargers 112, some embodiments of the system 100 may not comprise any electric vehicle chargers 112.

In some embodiments, the system 100 delivers electric power between two points. The distance between two points can be small (e.g., a few kilometers, a few hundred meters, etc.) or large (several hundreds or thousands of kilometers). For example, the system 100 may be used as a power line replacement. The canopy 115 may enclose (and/or elevate) one or more power-lines. In some such cases the system 100 may deliver low voltage power (e.g., less than or equal to about 250V), high voltage power (e.g., more than about 250V but typically several thousands of volts) or a combination thereof (e.g., both high voltage and low voltage power). In some cases, the system 100 may replace existing power-lines and/or methods of transmitting electrical power. In some cases, the system 100 delivers electrical power from a location where electrical power is generated (e.g. a power plant, a hydro-electric dam, etc.) to an end location (e.g. a city transfer station, a factory, etc.).

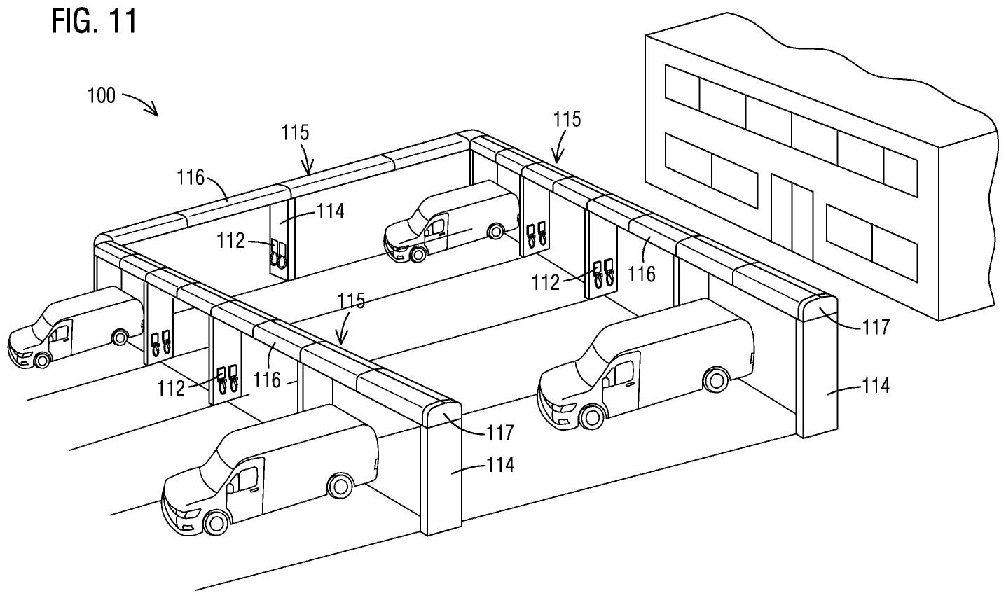

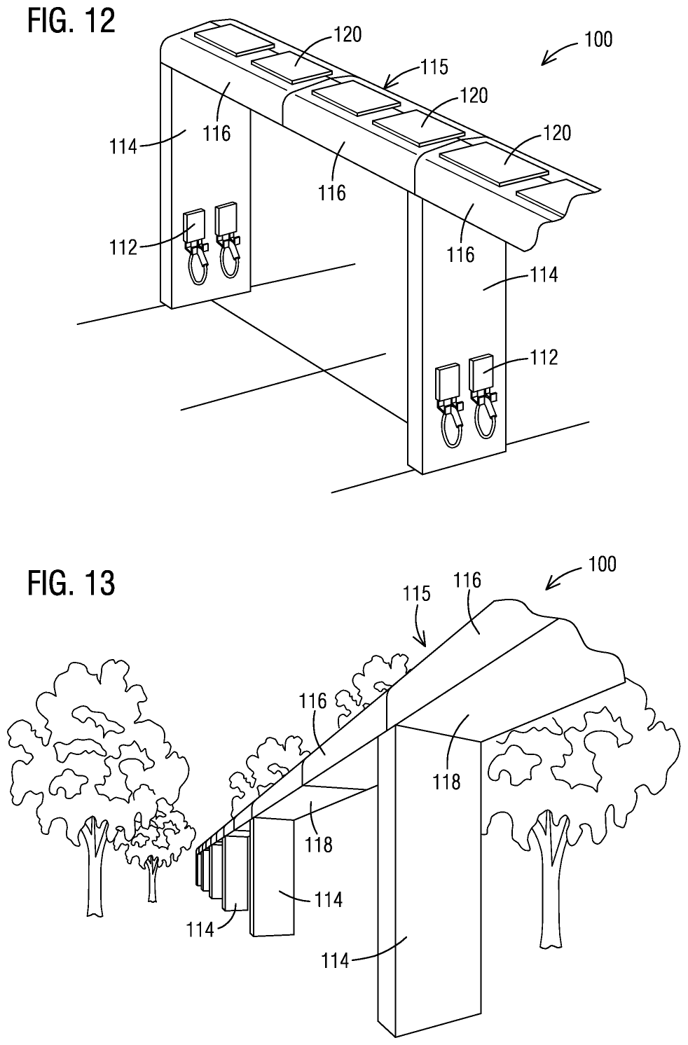

FIG. 13 schematically illustrates an example system 100 configured to deliver electrical power between two points which passes through a forest.

As described elsewhere herein, the canopy 115 may protect enclosed power lines from environmental elements (e.g., rain, snow, hail, wind, etc.), debris (e.g., tree branches, falling rocks, dust, etc.) and/or the like. Additionally, or alternatively, the canopy 115 may prevent electric shocking hazards such as for example protecting any humans, animals, property, etc. which may come to close to the system 100 from receiving an electric shock. Individual power lines within the canopy 115 (or the system 100) may be electrically isolated from one another to prevent short circuiting of the power lines, inadvertent connections (e.g., inadvertent electrical connections with unintended components of the system 100) and/or the like.

In some embodiments, the canopy 115 encloses fiber optic or other network cables (alone or in addition to one or more power lines).

The system 100 may comprise one or more electrical elements or devices to facilitate transmission of electrical power (and/or network signals). For example, the system 100 may comprise one or more transformers to vary a voltage of the transmitted electrical power. In some cases, the system 100 comprises one or more step-up transformers to increase a voltage of the electrical power such that the electrical power may be transmitted at a higher voltage. As another example, the system 100 may comprise one or more step-down transformers to lower the voltage of the electrical power at its destination.

In some cases, an end of the canopy 115 may be mounted to a building or other structure. In some such cases electrical power from the building or other structure may be coupled to the electric power distribution system (or enclosed power line(s)). Additionally, or alternatively, the end may be structurally supported by the building or structure instead of a column 114.

In some cases, at least a portion of the canopy 115 may be coupled to (and/or structurally supported by) features other than columns 114. For example, the canopy 115 may be coupled to bridge trusses, building roofs, span between two buildings, etc.

For the purposes described herein an electric vehicle includes any vehicle that is either fully electrically powered or partially electrically powered and that requires electric charging of one or more on board batteries. Such vehicles may include but are not limited to passenger cars, delivery vans, trucks, busses, airplanes, marine vessels, mobile machinery, etc.

In some embodiments, a system provides load bearing vertical pillars, anchored into the ground, which are topped with a horizontal beam system. This beam system supports the weight load of a busway system which can then deliver electricity to installed loads (e.g., electric vehicle charging equipment, power outlets, lighting, etc.) and/or receive power from non-utility power sources (e.g. solar, wind, battery, generator, etc.). This busway is then housed in an enclosure to limit exposure to weather elements. The entire system is expandable, and can be extended in modules to accommodate specific installation requirements.

This invention supports weight of overhead mounted busway, which limits installation requirements when no existing structure is available. It protects busway systems from the elements, which allows for the use of IP55 rated busway in an outdoor setting.

FIG. 14 shows a perspective view of a completed assembly 200 including vertical sections 201 including a crush zone 209, screw pile anchors 202 with a leveling plate 208, and horizontal cross beams 203, a busway system with busplugs 204 mounted on a mounting cross bar 210, and a top cover 205.

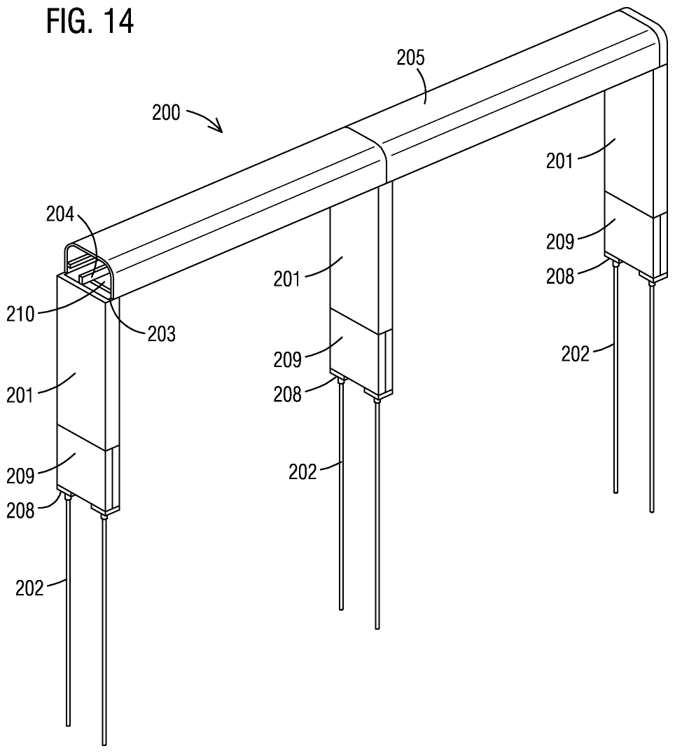

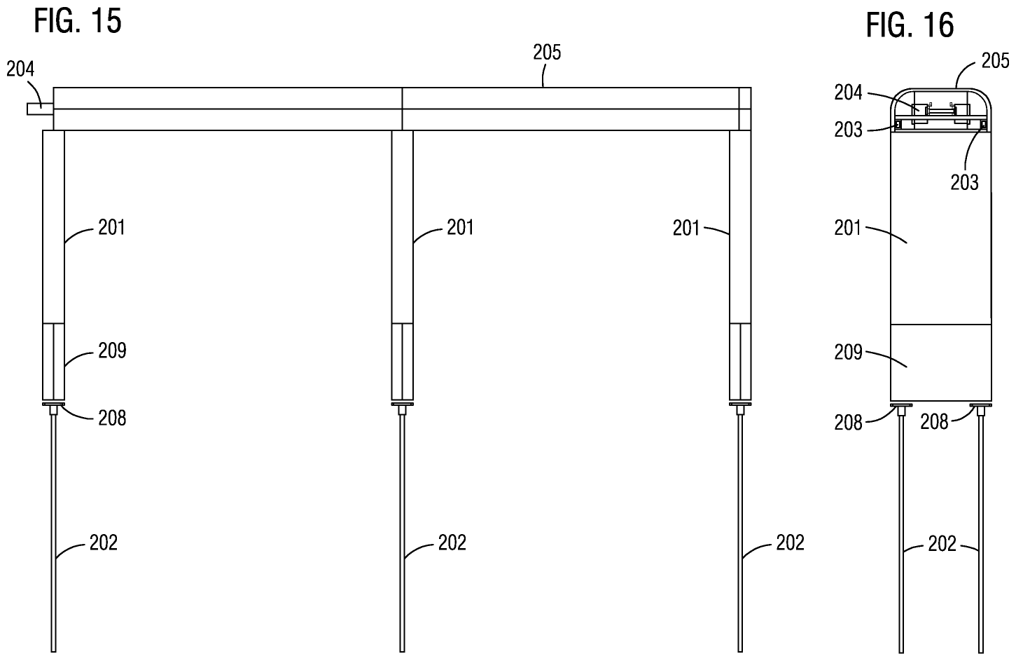

FIGS. 15-16 show side and front views of the completed assembly 200 including vertical sections 201, the screw pile anchors 202 with the leveling plate 208 and the horizontal cross beams 203, the busway system with busplugs 204, and the top cover 205.

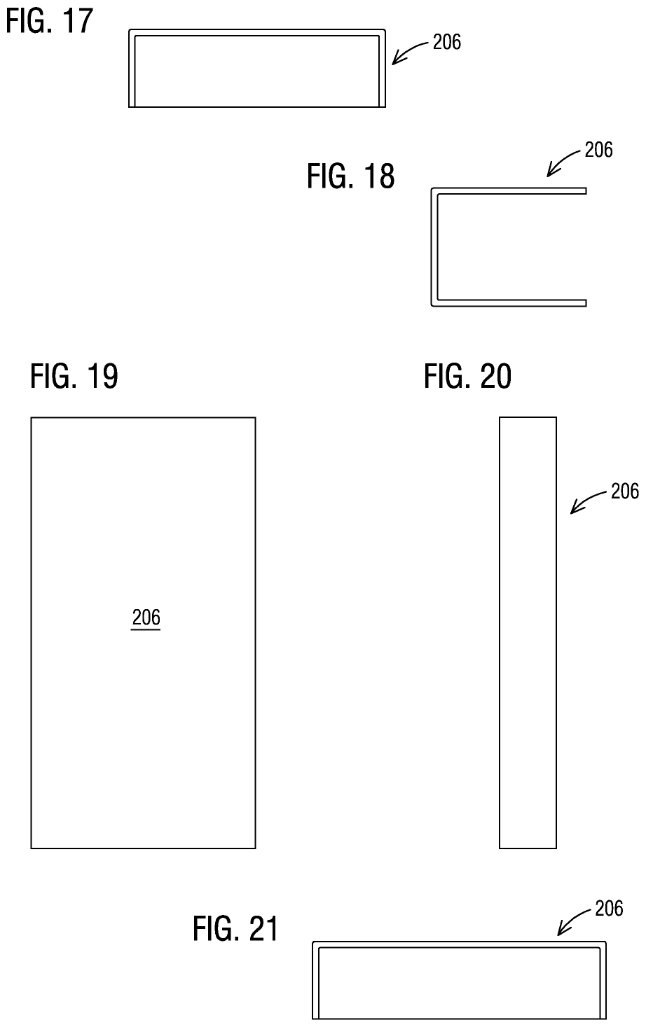

FIGS. 17-21 show details of vertical components 206 of a vertical structure.

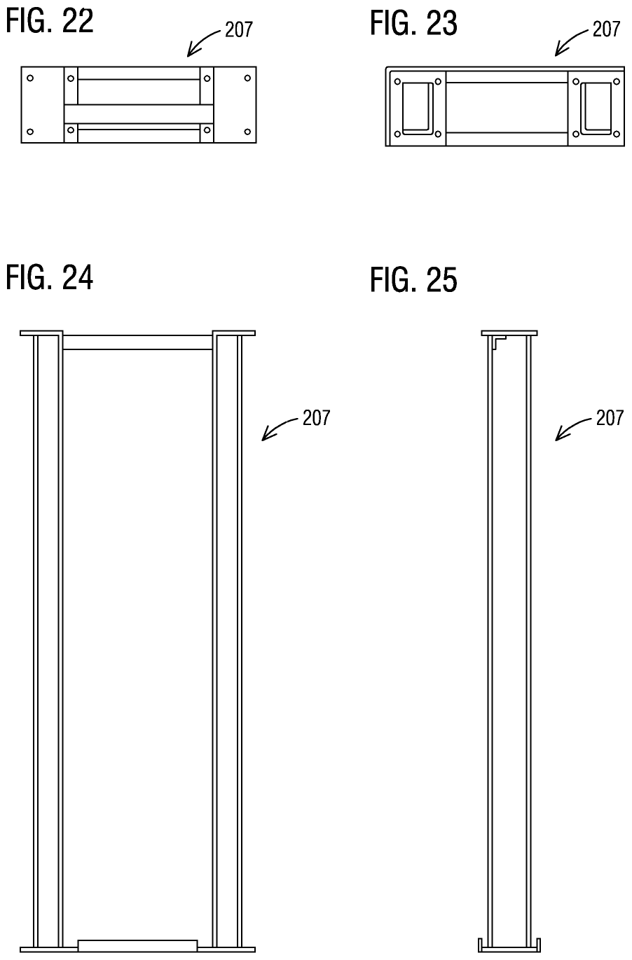

FIGS. 22-26 detail steel vertical components which are encased in a vertical panel such that steel vertical structures 207 are anchored to the top of the leveling plate 208.

FIGS. 27-29 detail a bottom portion of the vertical structure that is designed as a replaceable crush zone 209.

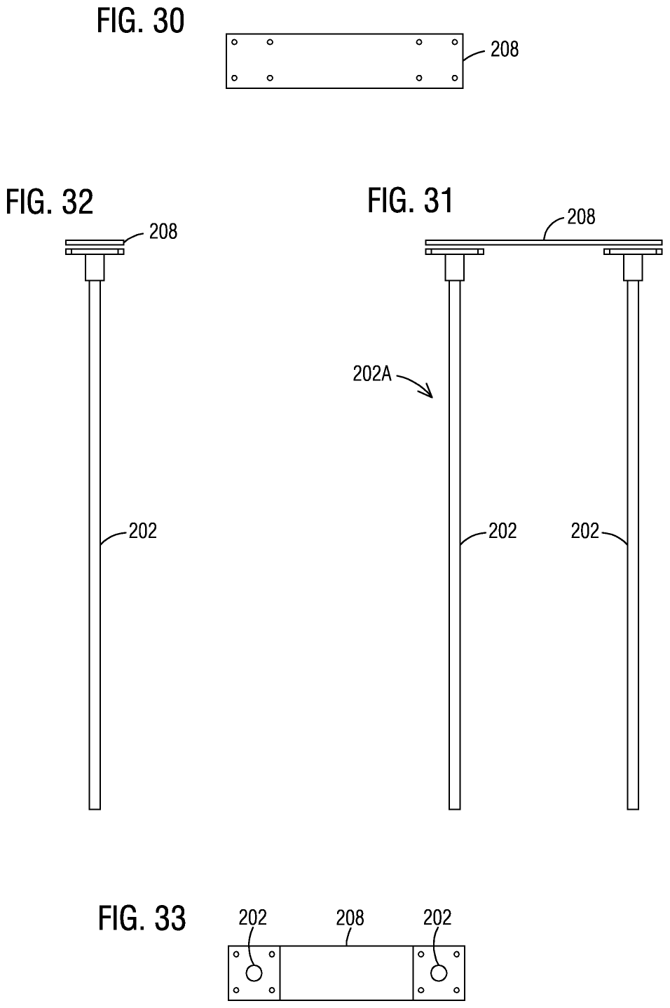

FIGS. 30-33 detail a screw pile anchoring system 202A and the leveling plate 208 that ensures that the vertical components are installed correctly.

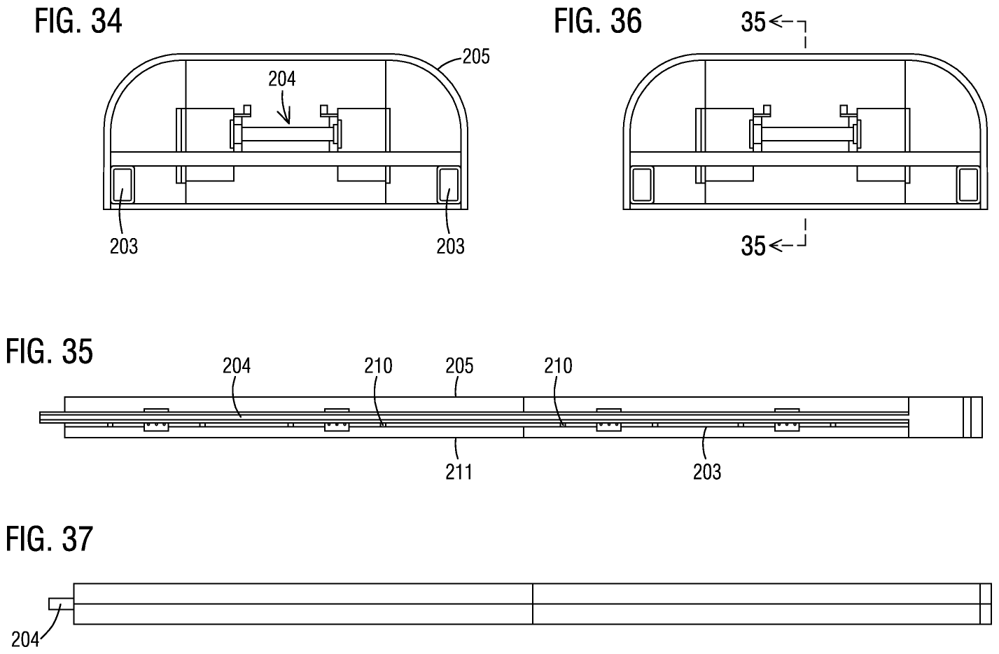

FIGS. 34-38 show horizontal components of horizontal assemblies wherein the horizontal components are comprised of steel cross beam 203, the busway system including mounting cross bars 210, busduct, busplugs and tap boxes. These busway components are installed on top of the steel cross beams 203. A top cover 205 is installed to protect the busway system from the elements. An under-side access panel 211 is installed to isolate the busway system from the public access and from pest infestations.

FIG. 39 illustrates a freestanding outdoor modular enclosure system 100(1) for busway applications in accordance with an exemplary embodiment of the present invention. The freestanding outdoor modular enclosure system 100(1) comprises a busway system 405 configured to deliver electricity to installed loads and/or receive power from utility or non-utility power sources and one or more load bearing vertical pillars 407(1-j) configured to be anchored into the ground. The freestanding outdoor modular enclosure system 100(1) further comprises a horizontal beam system 410 which is topped on the one or more load bearing vertical pillars 407(1-j). The horizontal beam system 410 supports a weight load of the busway system 405 and an enclosure 415 to house the busway system 405 to limit exposure to weather elements. The freestanding outdoor modular enclosure system 100(1) is modular and expandable and can be extended in modules to accommodate specific installation requirements. The horizontal beam system 410 includes a pair of horizontal cross beams 420(1-2) and the busway system 405 includes busduct, busplugs and/or tap boxes such that the busway system 405 is mounted on a mounting cross bar 425. The enclosure 415 includes a top cover 430 that protects the busway system 405 from elements. The busway components including the busduct, busplugs, tap boxes and the mounting cross bar 425 are installed on top of the pair of horizontal cross beams 420(1-2).

In the freestanding outdoor modular enclosure system 100(1), each of the one or more load bearing vertical pillars 407(1-j) includes a vertical section 435 including a crush zone 440 and a screw pile anchoring system 442 with a leveling plate 445. The screw pile anchoring system 442 and the leveling plate 445 ensures that vertical components are installed correctly. The crush zone 440 being a bottom portion of a vertical structure is designed as a replaceable structure with the anticipation that this could be installed in parking lots or other high traffic areas. In the freestanding outdoor modular enclosure system 100(1), each of the one or more load bearing vertical pillars 407(1-j) include vertical steel or other reinforcing structures that are anchored to the top of the leveling plate 445.

The freestanding outdoor modular enclosure system 100(1) further comprises an under-side access panel 450 that is installed to isolate the busway system 405 from public access and from pest infestations. The freestanding outdoor modular enclosure system 100(1) further comprises an IP55 rated busway installed in an outdoor setting.

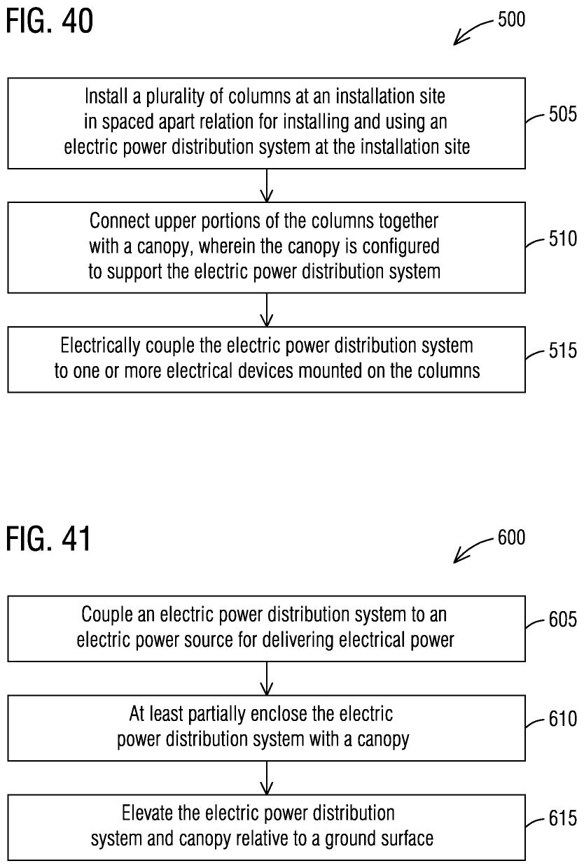

FIG. 40 illustrates a schematic view of a flow chart of a method 500 of installing and using the electric power distribution system 113 at an installation site in accordance with an exemplary embodiment of the present invention. Reference is made to the elements and features described in FIGS. 1-39. It should be appreciated that some steps are not required to be performed in any particular order, and that some steps are optional.

The method 500 comprises a step 505 of installing a plurality of columns at the installation site in spaced apart relation. The method 500 further comprises a step 510 of connecting upper portions of the columns together with a canopy. The canopy is configured to support the electric power distribution system 113. The method 500 further comprises a step 515 of electrically coupling the electric power distribution system 113 to one or more electrical devices mounted on the columns.

FIG. 41 illustrates a schematic view of a flow chart of a method 600 of delivering electrical power in accordance with an exemplary embodiment of the present invention. Reference is made to the elements and features described in FIGS. 1-39. It should be appreciated that some steps are not required to be performed in any particular order, and that some steps are optional.

The method 600 comprises a step 605 of coupling the electric power distribution system 113 to an electric power source. The method 600 further comprises a step 610 of at least partially enclosing the electric power distribution system 113 with a canopy. The method 600 further comprises a step 615 of elevating the electric power distribution system 113 and the canopy relative to a ground surface.

While a design of a busway system is described here a range of one or more other power distribution systems are also contemplated by the present invention. For example, other power distribution systems may be implemented based on one or more features presented above without deviating from the spirit of the present invention.

The techniques described herein can be particularly useful for a canopy feature built in an overhead power distribution system. While particular embodiments are described in terms of the canopy feature, the techniques described herein are not limited to such designs but can also be used with other enclosure designs.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

1.-60. (canceled)

61. A modular system for distributing electric power, the system comprising:
a plurality of columns, each of the plurality of columns spaced apart from one another;
an electric power distribution system configured to supply electric power, the electric power distribution system elevated by the plurality of columns and coupled to an electric power source, wherein the electric power distribution system comprises an electric busway;
a canopy at least partially enclosing the electric power distribution system, the canopy structurally supported by the plurality of columns and spanning between adjacent ones of the plurality of columns; and
a plurality of electric vehicle chargers coupled to the plurality of columns, each of the plurality of electric vehicle chargers electrically coupled to the electric power distribution system.

62. The system of claim 61, wherein the canopy comprises a plurality of separate canopy elements coupled together, wherein the plurality of canopy elements are removably coupled together.

63. The system of claim 62, wherein an end of at least one of the canopy elements comprises a lip that is engageable with an opposing end of an adjacent canopy element.

64. The system of claim 61, wherein the canopy is removably coupled to the plurality of columns, wherein the plurality of columns comprises prefabricated columns.

65. The system of claim 61, wherein a first column of the plurality of columns is a different height than a second column of the plurality of columns.

66. The system of claim 61, wherein the canopy comprises at least one access point, the access point configured to provide access to the electric power distribution system or an internal space within the canopy.

67. The system of claim 61 further comprising:
a cap coupled to at least one end of the canopy, the cap configured to seal the end of the cap.

68. The system of claim 61, further comprising:
sheathing coupled to the canopy, wherein the sheathing covers an open surface of the canopy, wherein the open surface is a bottom surface of the canopy, wherein one or both of the canopy and the sheathing comprise at least one aperture to vent the canopy, and wherein the at least one aperture maintains a temperature of the electric power distribution system within a desired operating range.

69. The system of claim 61, further comprising:
at least one cooling element within the canopy, the at least one cooling element configured to maintain a temperature of the electric power distribution system within a desired operating range.

70. The system of claim 61, wherein the canopy further comprises:
a plurality of cross-bars, the cross-bars stabilizing or structurally supporting the electric power distribution system within the canopy, wherein the cross-bars at least partially level the electric power distribution system within the canopy, wherein the cross-bars at least partially isolate the electric power distribution system from vibrations or movement of the canopy, wherein the cross-bars are electrically isolated from the electric power distribution system, wherein one or more components of the electric power distribution system are electrically isolated from one another.

71. The system of claim 61, wherein at least one of the plurality of columns is configured to withstand a vehicular impact.

72. The system of claim 61, wherein the canopy is overhead of the plurality of columns.

73. The system of claim 61 further comprising:
one or more solar panels or solar cells at least partially supported by the canopy, wherein the one or more solar panels or solar cells are configured to supply electric power to the electric power distribution system.

74. A freestanding outdoor modular enclosure system for busway applications, the system comprising:
a busway system configured to deliver electricity to installed loads and/or receive power from utility or non-utility power sources;
one or more load bearing vertical pillars configured to be anchored into the ground;
a horizontal beam system which is topped on the one or more load bearing vertical pillars, wherein the horizontal beam system supports a weight load of the busway system; and
an enclosure to house the busway system to limit exposure to weather elements, wherein the freestanding outdoor modular enclosure system is modular and expandable and can be extended in modules to accommodate specific installation requirements, wherein each of the one or more load bearing vertical pillars includes a vertical section including a crush zone being a replaceable portion of a vertical pillar designed to absorb and/or withstand a vehicular impact and a screw pile anchoring system with a leveling plate.

75. The system of claim 74, wherein the horizontal beam system includes one or more horizontal cross beams and the busway system includes busduct, busplugs and/or tap boxes such that the busway system is mounted on a mounting cross bar.

76. The system of claim 74, wherein each of the one or more load bearing vertical pillars include vertical steel or other reinforcing structures that are anchored to the top of the leveling plate.

77. The system of claim 74, wherein the screw pile anchoring system and the leveling plate ensures that vertical components are installed correctly.

78. The system of claim 75, wherein busway components including the busduct, busplugs, tap boxes and the mounting cross bar that are installed on top of the one or more horizontal cross beams.

79. The system of claim 74, wherein the enclosure includes a top cover that protects the busway system from elements.

80. The system of claim 74, wherein the crush zone being a bottom portion of a vertical structure is designed as a replaceable structure with the anticipation that this could be installed in parking lots or other high traffic areas.

81. The system of claim 74, further comprising:
an under-side access panel that is installed to isolate the busway system from public access and from pest infestations, wherein the busway system further comprises:
an IP55 rated busway installed in an outdoor setting.
